(19) United States
(12) Patent Application Publication
(10) Pub. No.: US 2005/0093531 A1
(43) Pub. Date: May 5, 2005

(54) Apparatus and method for a low voltage bandgap voltage reference generator

(75) Inventors: Pieter Vorenkamp, Laguna Niguel, CA (US); Venugopal Gopinathan, Irvine, CA (US)

Correspondence Address: STERNE, KESSLER, GOLDSTEIN & FOX PLLC, 1100 NEW YORK AVENUE, N.W., WASHINGTON, DC, 20005, US

(73) Assignee: Broadcom Corporation, Irvine, CA (US)

(21) Appl. No.: 10/878,994

(22) Filed: Jun. 30, 2004

Related U.S. Application Data
(60) Provisional application No. 60/498,365, filed on Aug. 28, 2003.

(51) Int. Cl. G05F 3/16

(52) U.S. Cl. 323/316

(57) ABSTRACT

A bandgap voltage generator generates an output reference voltage and is configured to operate from a low voltage power supply and consumes low power. The bandgap voltage generator includes a non-cascode current mirror that is directly connected to a power supply input and that produces current mirror outputs in response to the power supply input. A differential amplifier senses two of the current mirror outputs, and generates an output that controls the non-cascode current mirror so that the current mirror outputs produce substantially the same current and voltage at the sensed current mirror outputs. A bandgap core circuit includes first and second bipolar devices that receive the constant current from the two current mirror outputs. The first bipolar device is scaled in size relative to the second bipolar device so as to produce an output voltage at a third current mirror output that is multiple of the characteristic bandgap voltage of the bipolar devices. The non-cascode current mirror includes FET devices having their respective sources connected to the power supply input, and having their respective drains connected to the respective current mirror outputs. The FETs are not implemented with a cascode configuration, so that the bandgap voltage generator can operate with a low voltage power supply and also consumes low power.

### CROSS REFERENCED TO RELATED APPLICATIONS

This application claims the benefit of U.S. Provisional Application No. 60/498,365, filed on Aug. 28, 2003, which is incorporated by reference herein in its entirety.

### BACKGROUND OF THE INVENTION

1. Field of the Invention

The present invention generally relates to a bandgap voltage generator circuit, and more particularly to a bandgap voltage generator circuit that operates with a low supply voltage.

2. Related Art

Analog circuits often require an internally generated voltage reference in order to perform certain high performance functions, such as analog to digital conversion. The voltage reference should be stable and immune from temperature and power supply variations since the overall circuit performance will be negatively effected by any variation in the voltage reference. For example, the conversion accuracy of signals converted from analog-to-digital and digital-to-analog is directly dependent on the accuracy of the internal voltage reference.

Furthermore, the circuit that generates the voltage reference should be as physically small as possible, and should be able to operate at a low power supply voltage, consume low power.

A bandgap voltage reference is a solution that is commonly used to generate an internal voltage reference. Ideal bandgap voltage references provide a predetermined output voltage that is substantially invariant with temperature by taking a weighted sum of a voltage that has a negative temperature coefficient (viz the voltage across the PN junction) and one that has a positive temperature coefficient (viz the difference in voltage between two PN junctions carrying different current densities).

FIG. 1 illustrates a conventional bandgap voltage generator 100. The bandgap voltage generator 100 generates a output reference voltage 120 that is generally process and temperature independent. In other words, the output reference voltage 120 does not vary with temperature changes or variations of the semiconductor process. This occurs because the output reference voltage 120 is the weighted sum of V_{be} of bipolar device 116c. The bandgap voltage is a semiconductor device characteristic.

The bandgap voltage generator 100 includes a cascode current mirror 104 having cascode FETs 114a-c, a differential amplifier 106, and bipolar devices 116a-c. Each mirror within cascode FETs 114 include first FETs 115 and second FETs 117, where sources of the first FETs 115 are connected to the power supply 102, and the drains of the first FETs 115 are connected to the sources of the second FETs 117, as shown. The current mirror 104 produces outputs 118a, 118b, and 118c. The bipolar transistor 116a is configured so that its emitter is connected to the current mirror output 118a through a first resistor 108, and the bipolar transistor 116b is connected so that its emitter is connected to the current mirror output 118b. The bipolar transistor 116c is configured so that its emitter is connected to the current mirror output 118c, which also generates the output reference voltage 120. The bipolar transistors 116a-c are connected so that their respective bases and collectors are connected to ground (or another common voltage), forming diode devices. The size of the bipolar transistor 116b is scaled (1:N) relative to the bipolar transistor 116a, as will be discussed further herein. Furthermore, the resistor 110 can be scaled relative to the resistor 108.

As discussed above, the bandgap voltage generator 100 generates an output reference 120 that is generally process and temperature independent. In doing so, the current mirror 104 and the differential amplifier 106 operate in a feedback loop The differential amplifier 106 senses the voltages at the current mirror outputs 118a and 118b and generates an output 122 responsive thereto that adjusts the current in the current mirror 104 so that voltages and currents at the nodes 118a and 118b are substantially equal. More specifically, the differential amplifier 106 detects any differences between the currents and voltages at the nodes 118a and 118b, and adjusts the total current from the power supply 102 by controlling the gate voltages of the FETs 115 that are connected to the power supply 102, to eliminate any voltage or current difference at the mentioned nodes. By doing so, the resulting feedback loop forces the currents into the emitters of the bipolar transistors 116a, and 116b to be substantially the same.

The output voltage is the bandgap of silicon for a particular fixed weighted sum of V_{be} and ΔV_{be}. There are multiple ways to obtain this fixed ratio. For example, the resistor 110 can be scaled relative to the resistor 108. Alternatively, the current ratios can be scaled (i.e. unequal currents). This resistor scaling along with the scaling of the bipolar transistor 116b relative to the bipolar transistor 116a produces the output reference voltage 120 that is a multiple of the physical bandgap voltage of the bipolar devices 116. The bipolar devices 116a-c can be referred to as a bandgap core 112, since the relative scaling of the devices in the bandgap core determines the output reference voltage 120.

It is noted the current mirror 104 includes cascode devices 114 having a first FETs 115 and a second FETs 117 that are connected together in a cascode configuration. The first FETs 115 are connected to the power supply and are controlled by the differential amplifier output 122. The second FETs 117 generate the current mirror outputs 118a and 118b, and are connected to the differential input of the differential amplifier 106. The cascode FETs 114 require a higher voltage power supply to provide sufficient drain-to-source voltage for each of the two FETs in the cascode configuration.

What is needed is a bandgap voltage reference generator that provides a stable output voltage, but that operates with a low voltage power supply, and that consumes low power.

### SUMMARY OF THE INVENTION

In one embodiment, the present invention is a bandgap voltage generator that generates an output reference voltage that is relatively stable and independent of temperature and process variations. The bandgap voltage generator includes a non-cascode current mirror that is directly connected to a power supply input and that produces first, second, and third current mirror outputs. A differential amplifier senses first and second current mirror outputs, and generates an amplifier output that controls the non-cascode current mirror so that the first and second current mirror outputs have substantially the same voltage. A bandgap core circuit includes first and second bipolar devices that receive the constant currents from the first and second current mirror outputs. The first bipolar device is scaled in size relative to the second bipolar device so as to produce an output voltage at the third current mirror output that is multiple of the characteristic bandgap voltage.

The non-cascode current mirror includes first, second, and third FETs having their respective sources directly connected to the power supply input, and having their respective drains connected to the respective current mirror outputs, and having their respective gates connected together and controlled by the output of the differential amplifier. Since the cascade devices were taken out, the bandgap voltage generator of the present invention can operate with a low voltage power supply.

The differential amplifier is configured so as to detect and amplify any difference between the first and second current mirror outputs. The differential amplifier output is applied to the gates of the FETs in the current mirror, so that a feedback loop is formed.

The first and second bipolar devices are configured as diode devices by grounding their respective bases and collectors. Alternatively, the diodes can be formed by connecting the respective bases and collectors to any common voltage. The first and second bipolar devices are scaled N:1 to generate the output reference voltage that is based on the characteristic semiconductor bandgap of the bipolar devices. Furthermore, a third bipolar device is also connected to the third current mirror output in the bandgap core. The third FET device that generates the third current mirror output can also be scaled to further adjust the output reference voltage, as desired.

Further features and advantages of the present invention, as well as the structure and operation of various embodiments of the present invention, are described in detail below with reference to the accompanying drawings.

### BRIEF DESCRIPTION OF THE FIGURES

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 illustrates a cascode bandgap voltage generator circuit.

FIG. 2 illustrates a low voltage bandgap voltage generator circuit according to embodiments of the invention.

FIG. 3 illustrates a flowchart 300 that describes operation of the low voltage bandgap generator circuit according to embodiments of the present invention.

### DETAILED DESCRIPTION OF THE INVENTION

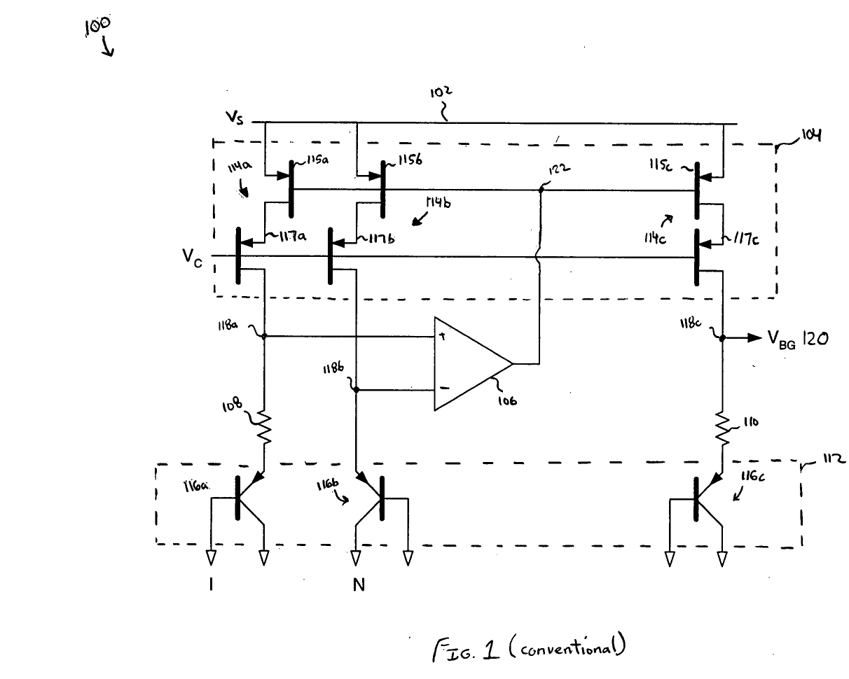

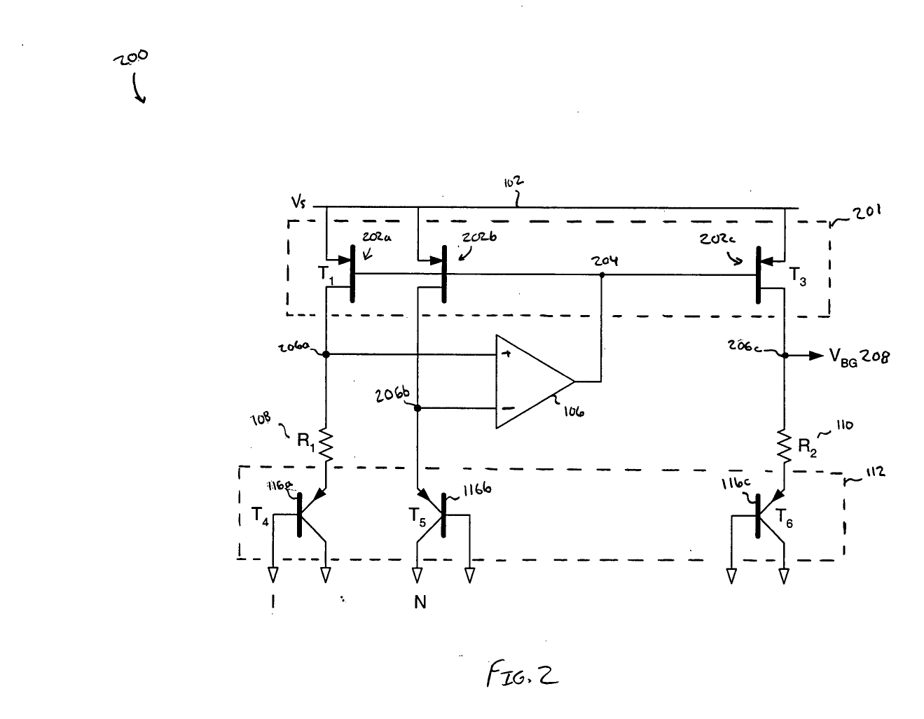

FIG. 2 illustrates a bandgap voltage generator circuit 200 according to embodiments of the present invention. The bandgap generator circuit 200 generates an output reference voltage 208 that is generally process and temperature independent. In other words, the output reference voltage 208 does not vary with temperature changes or variations in the performance of the semiconductor process, similar to the voltage output 120 that is produced by the bandgap voltage generator 100 of FIG. 1. However, the bandgap voltage generator 200 is configured without the cascode connected FETs in the current mirror. Therefore, the bandgap voltage generator 200 can operate with a lower power supply voltage than the bandgap voltage generator 100.

The bandgap voltage generator 200 includes a non-cascode current mirror 201 having FETs 202a-c, a differential amplifier 106, and a bandgap core having the bipolar transistors 116a-c. The current mirror 201 produces current mirror outputs 206a, 206b, and 206c. The differential amplifier senses the current mirror outputs 206a and 206b to produce a differential amplifier output 204 that controls the current mirror 201. The bipolar transistor 116a is configured so that its emitter is connected to the current mirror output 206a through the first resistor 108, and the bipolar transistor 116b is configured so that its emitter is connected to the current mirror output 206b. The bipolar transistor 116c is connected so that its emitter is connected to the current mirror output 206c through the second resistor 110, where the current mirror output 206c also generates the output reference voltage 208. The bipolar transistors 116a-c are connected so that their respective bases and collectors are connected to ground, forming diode devices. Alternatively, the bases and collectors of the transistors 116a-c can be connected to any common voltage to form the diode devices (e.g. non-ground). The size of bipolar device 116b is scaled (1:N) relative to the bipolar device 116a, as will be discussed further below. Furthermore, the size of the resistor 110 is scaled relative to the resistor 108. The relative scaling of the bipolar transistors 116 and the relative scaling of the resistors 110,108 cause the output reference voltage 208 that is generated to be based on upon the semiconductor bandgap voltage of the bipolar transistors 116. More specifically, the output reference voltage 208 is a multiple of the semiconductor bandgap of the bipolar transistors 116, where the multiple is determined by the relative scaling of the bipolar transistors 116a and 116b and the relative scaling of the resistors 108 and 110.

As discussed above, the bandgap generator circuit 200 generates an output reference voltage 208 that is generally process and temperature independent. In doing so, the current mirror 201 and the differential amplifier 106 operate as a feedback loop that forces the currents through and the voltages at the current mirror outputs 206a and 206b to be equal. The differential amplifier 106 senses the voltage at the current mirror outputs 206a and 206b and generates an amplifier output 204 responsive thereto that adjusts the current in the current mirror 201 so that voltages at the nodes 206a and 206b are substantially the same and constant. More specifically, the differential amplifier 106 adjusts the individual currents of the FETs 202 by controlling the gate voltages of the FETs 202, and thereby controlling the current and voltage produced by the current mirror 201. By doing so, the resulting feedback loop forces the voltages at 206a and 206b to be substantially the same. The FET 202c generates a mirror current at the output 202c since the FET 202c is also part of the current mirror 201 and has its gate voltage controlled by the amplifier output 204. The current output of FET 202c is a function of the relative transistor sizes. In other words, the current mirror output 206c can be scaled relative to the current mirror outputs 206a and 206b by scaling the transistor sizes.

Furthermore, the resistor 110 can be scaled relative to the resistor 108. This resistor scaling along with the bipolar transistor 116b relative to bipolar transistor 116a produces the output reference voltage 208 that is a multiple of the physical bandgap voltage of the bipolar devices 116. Furthermore, the output reference voltage 208 can be further scaled by adjusting the relative transistor sizes.

It is noted that the current mirror 201 is not in a cascode configuration. The FETs 202a-c in the current mirror 201 are directly connected to the power supply 102 and are not implemented with the cascode configuration of the current mirror 104 of the cascode bandgap voltage generator 100. Accordingly, the drains of the FETs 202a-c are connected to the respective current mirror outputs without any intervening transistors. As a result, the bandgap voltage generator 200 can operate with a lower power supply voltage relative to the bandgap voltage generator 100 because only a single stage (or row) of FETs 202 need to be biased compared with the two rows of FETs in the cascode configuration 114 of the bandgap voltage generator 100. Stated another way, the voltage drop from the power supply 102 to the current mirror outputs 206 is equivalent to the drain-to-source voltage drop across a single biased FET device, or another transistor device. Whereas, the corresponding voltage drop for the bandgap voltage generator 100 is equivalent to two drain-to-source voltage drops because the cascode configuration has two FETs that require biasing.

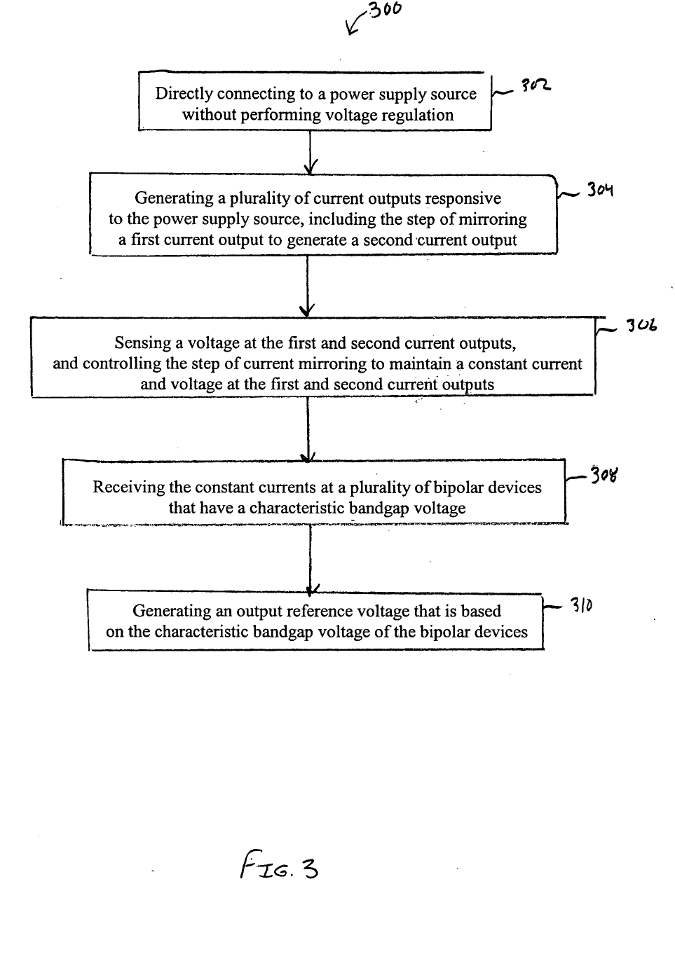

FIG. 3 illustrates a flowchart 300 that further describes the operation of the bandgap generator circuit 200 according to embodiments of the present invention.

In step 302, a power supply source is directly connected without performing any voltage regulation. For example, the power supply 102 is directly connected to the sources of the current mirror FETs 202a-c in the voltage reference generator 200. Therefore, the power supply voltage from the power supply source 102 can be reduced since only single row of FETs 202 needs to be biased.

In step 304, a plurality of current outputs is generated responsive to the power supply source. The current generating step includes the step of mirroring a first current output to generate a second current output. For example, the non-cascode current mirror 201 generates current mirror outputs 206a-c by mirroring the respective currents as determined by the control voltage 204 from the output of the differential amplifier 106. As discussed above, the control voltage 204 is applied to the gates of the FETs 202a-c, and therefore controls the current in the current outputs 206a-c from the current mirror 201.

In steps 306 and 308, voltages at the first and second current outputs are sensed so as to control the current mirroring step in step 304 to maintain a constant voltage at the first and second current outputs. For example, the differential amplifier 106 senses the voltages at the first and second current mirror outputs 206a and 206b. The differential amplifier output 204 adjusts the gates of the FETs 202a-c so as to maintain equal and constant voltages in the current mirror outputs 206a-c. In other words, voltages at 206a and 206b are adjusted to be equal and constant, and these constant currents flow into the bandgap core 112, including the bipolar devices 116a and 116b.

In step 310, the bandgap voltage generator 200 generates an output reference voltage 208 that is based on the characteristic bandgap voltage of the bipolar devices. More specifically, the FET 202c generates a current mirror output 206c that drives the resistor 110 and the bipolar device 116c to generate the output reference voltage 208 that is multiple on the semiconductor bandgap voltage associated with the bipolar devices 116, where the multiple is determined by the relative scaling of the bipolar devices.

The bandgap voltage generator 200 has been described so that the current mirror 201 is implemented using FETs. However, the invention is not limited to this example, and other equivalent transistors or semiconductor devices could be used. Furthermore, the bandgap core 112 has been described as being implemented using bipolar devices. However, the invention is not limited to these semiconductor devices, and other transistor or semiconductor devices could be used for the bandgap core 112, as long as these devices have a characteristic bandgap voltage associated with them.

### Conclusion

Example embodiments of the methods, systems, and components of the present invention have been described herein. As noted elsewhere, these example embodiments have been described for illustrative purposes only, and are not limiting. Other embodiments are possible and are covered by the invention. Such other embodiments will be apparent to persons skilled in the relevant art(s) based on the teachings contained herein. Thus, the breadth and scope of the present invention should not be limited by any of the above-described exemplary embodiments, but should be defined only in accordance with the following claims and their equivalents.

1. A bandgap voltage generator, comprising:
a non-cascode current mirror that is connected to a power supply input and that produces a plurality of current mirror outputs in response to said power supply input and a control input;
a differential amplifier for sensing first and second current mirror outputs of said non-cascode current mirror, and having an output responsive thereto that controls said non-cascode current mirror using said control input so that said current mirror outputs have substantially the same current and voltage;
a first bipolar device connected to a first current mirror output through a first resistor;
a second bipolar device connected to a second current mirror output; and
a third bipolar device connected to a third current mirror output through a second resistor, said third current mirror output producing a reference output voltage responsive to said power supply input.

2. The bandgap voltage generator of claim 1, wherein said non-cascode current mirror includes a plurality of transistors having first terminals connected to the power supply input, and second terminals connected to respective current mirror outputs, and having respective control terminals connected to said control input of said non-cascode current mirror.

3. The bandgap voltage generator of claim 1, wherein said non-cascode current mirror includes a plurality of FETs having their respective sources connected to said power supply input, and having their respective drains connected to respective current mirror outputs, and having their respective gates connected said output of said differential amplifier though said control input.

4. The bandgap voltage generator of claim 3, wherein a first FET of said plurality of FETs has its drain connected to said first current mirror output, and a second FET of said plurality of FETs has its drain connected to said second current mirror output, and a third FET of said plurality of FETs has its drain to connected to said third current mirror output.

5. The bandgap voltage generator of claim 1, wherein said second bipolar device is scaled relative to said first bipolar device.

6. The bandgap voltage generator of 5, wherein said second resistor is scaled relative to said first resistor.

7. The bandgap voltage generator of claim 1, wherein a voltage at said third current mirror output is based on a characteristic bandgap voltage of silicon.

8. The bandgap voltage generator of claim 7, wherein said voltage at said third current mirror output is a multiple of said bandgap voltage of said bipolar devices, said multiple dependent on a relative size ratio of said first bipolar device to said second bipolar device.

9. The bandgap voltage generator of claim 8, wherein said voltage at said third current mirror output is also based on a resistance ratio of said first resistor relative to said second resistor.

10. The bandgap voltage generator of claim 1, wherein said bipolar devices are diode connected transistors.

11. A method of generating a reference voltage, comprising:
directly receiving current from a power supply source;
generating a plurality of current outputs responsive to said power supply source, including the step of mirroring a first current output to generate a second current output;
sensing a voltage at said first and second current outputs, and controlling the step of mirroring to maintain a constant current and voltage at said first and second current outputs;
receiving said constant currents at respective first and second bipolar devices, the first and second bipolar devices having a characteristic bandgap voltage; and
generating an output reference voltage that is based on said characteristic bandgap voltage.

12. The method of claim 11, wherein said output reference voltage is a multiple of said characteristic bandgap voltage.

13. The method of claim 11, wherein the step of sensing includes the step of determining a difference between voltages at said current outputs, and the step of controlling includes the step of adjusting the step of current mirroring to reduce said difference between voltages at said first and second current outputs.

14. The method of claim 11, wherein the step of mirroring is performed without performing voltage regulation.

15. The method of claim 11, wherein the step of mirroring is performed by a non-cascoded circuit.

16. A bandgap voltage generator, comprising:
a non-cascode current mirror that is connected to a power supply and that produces a first, second, and third current mirror outputs in response to said power supply;
means for controlling said non-cascode current mirror so that said first and second current mirror outputs each produce a substantially constant current; and
a bandgap core circuit having first and second bipolar devices that receive said substantially constant currents from said first and second current mirror outputs;
said first and second bipolar devices having a characteristic bandgap voltage, and said first bipolar device scaled relative to said second bipolar device so as to produce an output voltage at said third current mirror output that is multiple of said characteristic bandgap voltage based on a size ratio of said first bipolar device to said second bipolar device.

17. The bandgap voltage generator of claim 16, wherein a voltage drop from said power supply to said first and second current mirror outputs is approximately equivalent to a voltage drop across a single biased transistor device.

18. The bandgap voltage generator of claim 17, wherein said voltage drop from said power supply to said first and second current mirror outputs is approximately equivalent to a single drain-to-source voltage drop across a single biased FET device.

19. The bandgap voltage generator of claim 16, wherein said non-cascode current mirror includes a plurality of transistors having first terminals connected to said power supply input, and second terminals connected to respective current mirror outputs, and having respective control terminals connected to said means for controlling said non-cascode current mirror.

20. The bandgap voltage generator of claim 19, wherein said second terminals are connected to said respective current mirror outputs without intervening transistors connected between said second terminals and said current mirror outputs.

21. The bandgap voltage generator of claim 16, wherein said non-cascode current mirror includes a plurality of FETs having their respective sources connected to said power supply input, and having their respective drains connected to respective current mirror outputs, and having their respective gates connected to said means for controlling.

22. The bandgap voltage generator of claim 21, wherein said respective drains are connected to said respective current mirror outputs without intervening transistors connected between said respective drains and said current mirror outputs.

23. The bandgap voltage generator of claim 1, wherein respective bases and collectors of said first, second, and third bipolar devices are connected to a common voltage.

24. The bandgap voltage generator of claim 23, wherein said common voltage is ground.

25. The bandgap voltage generator of claim 7, wherein said voltage at said third current mirror output is a multiple of said bandgap voltage of said bipolar devices, said multiple dependent on a ratio of said first resistor to said second resistor.
